(19) United States
(12) Patent Application Publication
(10) Pub. No.: US 2012/0306215 A1
(43) Pub. Date: Dec. 6, 2012

(54) Wind Turbine

(76) Inventors: Philip Wesby, Stratford-upon-Avon (GB); Christopher Turner, Hampshire (GB)

(21) Appl. No.: 13/578,377

(22) PCT Filed: Feb. 15, 2011
(86) PCT No.: PCT/GB2011/000193

§ 371 Date: Aug. 10, 2012

(30) Foreign Application Priority Data
Feb. 16, 2010 (GB) 1002558.3

(51) Int. Cl. F03D 9/00

(52) U.S. Cl. 290/55

(57) ABSTRACT

A system and method for fluid power conversion is described which can provide the basis for a new and improved wind turbine suitable to manufacture a horizontal axis (HAWT) or vertical axis (VAWT) turbine at one of a range of different power classes such as from 4 kiloWatts to 10 MegaWatts. In the case of the VAWT, the wind turbine comprises one or more turbine blades moving around a vertical axis wherein each blade is anchored to a central hub by at least one strut and by at least two cable wires. In the case of the HAWT, the wind turbine comprises two or more turbine blades moving around a horizontal axis wherein each blade is anchored to a central hub. The turbine central hub comprises a relatively large diameter, which is coupled to a power generation support structure via a plurality of roller bearings or the like. As the central hub turns, it drives the roller bearings, which are each coupled with a separate power generation component such as an electric generator or a hydraulic gearpump. This configuration of a large diameter central hub coupled to multiple electrical power generators and or gearpumps wherein each power generation component of the system is controlled by an intelligent central system controller, provides versatile control of the net output power generated by the turbine and thereby maximizes the efficiency of the turbine over a range of wind speeds. The electric generators and or hydraulic gearpumps may together comprise a range of power conversion ratings to further optimise and control the power output of the wind turbine over a range of wind speeds.

### BACKGROUND OF THE INVENTION

The invention relates to a system and method for fluid power conversion, which is suitable for turbine power generation systems. More particularly, it relates to a system and method for fluid power conversion in wind turbines, which is highly suited to both Vertical Axis Wind Turbines (VAWTs) and Horizontal Axis Wind Turbines (HAWTs) which may form the base technology for the manufacture of wind turbines at one of a range of different power classes such as at 4 kiloWatts, 40 kW, 400 kW, 4 MW and 10 MW. In the case of the VAWT, the wind turbine comprises one or more turbine blades moving around a vertical axis wherein each blade is anchored to a central hub by at least one strut and by at least two cable wires. In the case of the HAWT, the wind turbine comprises two or more turbine blades moving around a horizontal axis wherein each blade is anchored to a central hub. The turbine central hub comprises a relatively large diameter, which is coupled to a power generation support structure via roller bearings or the like. As the central hub turns, it drives the roller bearings, which are coupled with a plurality of electric generators and or hydraulic gearpumps.

In particular, the invention teaches a method, which provides higher efficiency of power generation over a range of wind speeds by using a plurality of power generation components such as electric generators and or hydraulic gearpumps. The said power generation components are driven by the movement of the turbine and are each controlled by an intelligent central system control means, which uses a self-learning algorithm and which can regulate the output of the power generation components and thereby optimise the power generated by the wind turbine over a range of wind speeds.

In essence, the invention makes possible the creation of a new class of high efficiency wind turbines, which are easier to service and more efficient to operate. Furthermore, the use of multiple power generation components, which may comprise different power generation ratings, makes possible intelligent and selective control of the said components and thereby makes possible higher efficiency of power generation in changing and variable wind conditions. The use of multiple power generation components also removes the need for a mechanical gearbox, thereby reducing cost and weight of the turbine.

This patent application relates in part at to an earlier patent application entitled System and Method for Hydraulic Power Transfer filed 19 Sep. 2008 with application number GB-A-0817202.5 to Philip Wesby and Roy Targonski.

Generally, vertical axis wind turbines (VAWTs) often suffer from lower performance when compared to horizontal axis wind turbines (HAWTs) due to their blades not comprising optimised chord lengths and cross sectional profiles. In addition, while VAWTs are always facing the wind whatever the direction of the wind, and can generate power as the wind direction changes, the turning blades move into and out of the wind as they turn, which causes a stress load on the turbine blades and support struts and wires, once per revolution. Consequently, solutions are needed to counter the effect of these cyclical forces.

The strut support of the VAWT is also moving into and out of the wind once per revolution and this provides drag on the turbine and thereby reduces its efficiency in power generation. Consequently a strut design is needed which comprises an aerodynamic profile to reduce this drag. In addition, the strut and the cable support wires, which hold the blade in place relative to the turning central hub, present resistance to the wind.

Horizontal axis wind turbines (HAWTs) generally comprise mechanical gearbox transmission systems. The gearbox is often a point of failure in wind turbines due to the high loading and changing forces exerted on the transmission system during operation. Shock loading of the transmission system occurs at the instant that power is taken from the wind and the shock loads can lead to failure of the gearbox.

In general, prior art wind turbines comprise a single turning shaft, which couples to a single power generation component. The high torque from this shaft requires a reliable mechanical transmission to transfer the power to an electric power generator. Improved transmission systems and methods are needed to distribute the torque generated by the wind turbine to a plurality of power generating components.

The system and method according to the invention makes possible the creation of a new class of both VAWT and HAWT wind turbines, which have high efficiency by transferring the high torque generated by the turbine using a plurality of power generation components such as electric generators and or hydraulic gearpumps which are located at a large distance from the axis of rotation by using a relatively large diameter central hub and central support column.

Today, it is standard practice to use multiple-blade vertical axis wind turbines but the high number of blades reduces the efficiency of the turbines and thus renders them uneconomical to deploy.

Large turbines having power outputs above 100 kW are very heavy to construct and each requires a very robust support tower to support the weight of the gearbox and an expensive electric generator, which is coupled to a single high torque drive shaft.

It is towards the creation of a new and more energy-efficient class of both VAWT and HAWT wind turbine that the current invention is directed.

No systems are presently known to the applicants, which address this market need in a highly effective and economic way.

Further to the limitations of existing technologies used for fluid power conversion in wind turbines, and so far as is known, no optimised system and method for fluid power conversion is presently available which is directed towards the specific needs of this problem area as outlined.

### OBJECTS OF THE INVENTION

Accordingly, it is an object of the present invention to provide an improved system and method for fluid power conversion which is suitable for application to both horizontal wind turbines (HAWTs) and vertical axis wind turbines (VAWTs) which can provide the basis of a new class of high performance turbine at a range of power classes such as 4 kW, 40 kW, 400 kW, 4 MW and 10 MW.

It is a further object of one embodiment of the present invention to provide a system and method for fluid power conversion for wind turbines wherein the blades of the turbine are integrated with a central support hub which rotates with the movement of the blades and which comprises a large diameter and which is securely coupled to a power generation support means by a plurality of roller bearings or direct drive gears or the like which are located in the structure of the said support means such that the movement of the central support hub causes the said roller bearings or the like to move wherein each is coupled with a power generation component.

It is a further object of one embodiment of the present invention to provide a system and method for fluid power conversion for wind turbines wherein the large diameter central hub turns to drive the said roller bearings or direct drive gears or the like which are located in the surface of the structure of the support means and wherein the roller bearings or direct drive gears or the like are coupled to a plurality of power generation components such as electric generators and or hydraulic gearpumps.

It is a further object of one embodiment of the present invention to provide a system and method for fluid power conversion for wind turbines comprising a large diameter central hub and support tower which comprises a plurality of roller bearings or direct drive gears or the like coupled to a plurality of power generation components, such as electric generators and or hydraulic gearpumps, wherein each of the said components comprise individual power output control means, and wherein the said power output control means may be further controlled by a central system power control means which enables the power output of each of the said components to be coupled to the turning central hub to generate power, or decoupled from the turning central hub so that the component generates no or reduced power.

In this way the total power output generated by the sum of each of the individual power generation components may be controlled and optimized according to the prevailing wind conditions and over a range of wind speeds.

It is a further object of one embodiment of the present invention to provide a system and method for fluid power conversion for wind turbines comprising a large diameter central hub and support tower which comprises a plurality of roller bearings or direct drive gears or the like coupled to a plurality of power generation components and a central system controller and wherein the power rating of the said power generation components may form one or more binary sets of power generation classes such that the lowest power rating comprises P kilowatts and wherein the power ratings of the other components in the same binary set comprises a power generation component of 2 P kilowatts, a power generation component of 4 P kilowatts, a power generation component of 8 P kilowatts and the like. In this way, selective control of each of the power generation components of each binary set of components makes possible versatile control of the output of the turbine.

It is a further object of one embodiment of the present invention to provide a system and method for fluid power conversion for vertical axis wind turbines wherein the turbine comprises one or more turbine blades and wherein each turbine blade is connected to the central hub by way of a strut and one or more support wires and wherein the strut and the support wires are angled upwards from the central hub and the strut and support wires maintain the turbine blade in a vertical orientation.

It is a further object of one embodiment of the present invention to provide a system and method for fluid power conversion for vertical axis wind turbines wherein the turbine comprises a single turbine blade and a counterweight structure.

It is a further object of one embodiment of the present invention to provide a system and method for fluid power conversion for vertical axis wind turbines wherein the turbine blade comprises an elliptical profile with tapering ends to reduce drag as the turbine turns.

It is a further object of one embodiment of the present invention to provide a system and method for fluid power conversion for vertical axis wind turbines wherein the vertical turbine blade curves inwards at the top of the blade to provide resistance against centrifugal forces as it moves at high speed.

It is a further object of one embodiment of the present invention to provide a system and method for fluid power conversion for vertical axis wind turbines wherein a high power turbine according to the invention may comprise a single blade turbine and strut wherein the blade height may be 50 m, the strut length may be 80 m and the central hub may have a diameter of 20 m.

It is a further object of one embodiment of the present invention to provide a system and method for fluid power conversion for vertical axis wind turbines which comprises a central system power control means which controls the operation of each of the separate power generation components by way of a fuzzy logic controller and self-learning algorithm and wherein the said controller develops an optimum power generation control method over time based upon performance data stored for the wind turbine at that location and in reference to the wind conditions of that location.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for fluid power conversion, which serves to address the diverse requirements for creating a new class of robust, high energy-efficient, low-cost vertical axis wind turbine (VAWT) which can provide a means for improved power generation over a range of wind speeds at a particular location.

The invention teaches a system and method for fluid power conversion which makes the first disclosure of a fuzzy-logic controlled power generation means which enables intelligent control of a plurality of power generation components located at a relatively large distance from the axis of rotation.

The invention makes possible the creation of a new class of high performance wind turbines (VAWTs and HAWTs)) capable of maximizing the energy generated by the wind by selective control of separate power generation components. Moreover, the central wind turbine blade hub comprises a large diameter and is coupled to a large diameter support means comprising roller bearings or the like, wherein each roller bearing or the like couples directly with an electric generator and or a hydraulic gearpump. The increased distance that each power generation component is separated from the axis of rotation enables each to be driven at a decreased torque that is delivered to the said roller bearings or the like by the rotating central support hub and this makes possible the use of a plurality of power generation components.

In particular, this makes possible the use of smaller and cheaper power generation components, which are more readily available than a single high power component, which may likely fail at high torques when the turbine is turning in high wind speeds.

In a preferred embodiment, a single vertical blade comprising a high performance profile is connected to the central support hub by way of a strut held at an inclined angle to the plane of rotation. A number of support wires between the central hub and the blade further may be added to increase the control of the blade structure and a counter-weight serves to balance the turning VAWT blade and support strut.

Other objects and features of the present invention will become apparent from the following detailed description considered in connection with the accompanying drawings, which disclose several key embodiments of the invention. It is to be understood, however, that the drawings are designed for the purpose of illustration only and that the particular descriptions of the invention in the context of the wind turbine application are given by way of example only to help highlight the advantages of the current invention and do not limit the scope of the invention.

### BRIEF DESCRIPTION OF THE DRAWINGS

FIG. 1 illustrates a schematic of a VAWT wind turbine comprising the fluid power conversion system according to one embodiment of the invention.

FIG. 2A illustrates a schematic of the power transfer control system according to one embodiment of the invention.

FIG. 2B illustrates a schematic of the power transfer control system according to a second embodiment of the invention.

FIG. 3 illustrates a schematic of one example of the blade profile and strut for a single blade VAWT wind turbine according to one embodiment of the invention.

FIG. 4 illustrates a schematic of the central system control architecture.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims.

The following description makes full reference to the detailed features which may form parts of different embodiments as outlined in the objects of the invention. In the following example reference is made to a system comprising electric generators and gearpumps while it is to be understood that the invention covers other embodiments which use other types of hydraulic pumps such as piston pumps and vane pumps and the like. Other embodiments may use fixed or variable displacement hydraulic pumps. Furthermore, in different embodiments, power generation components may comprise permanent magnet generators and or asynchronous generators and be of different power ratings to further increase the control over the net power output of the wind turbine and thereby improving its efficiency in varying wind conditions.

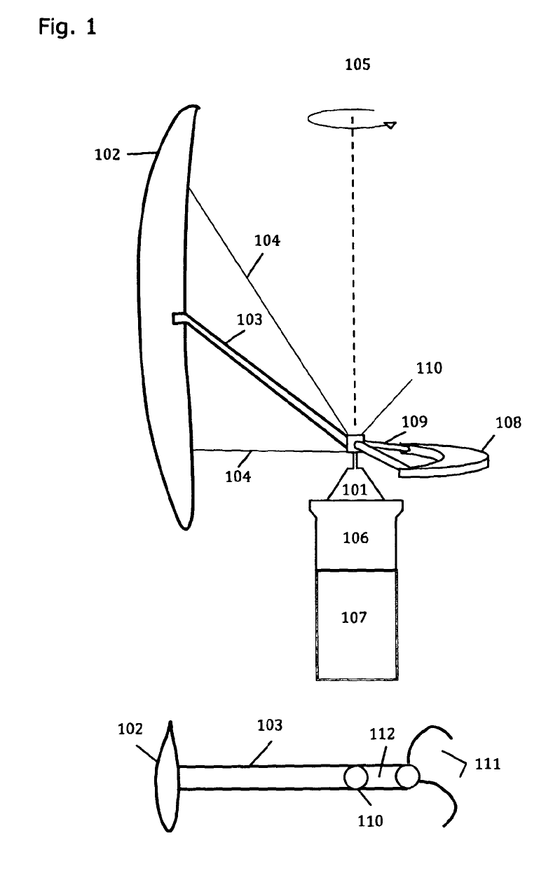

Referring now in detail to the drawings and in particular FIG. 1 thereof, therein illustrated is a schematic showing a fluid power conversion system according to the invention.

In FIG. 1, is shown a schematic of a VAWT wind turbine according to the current invention. A central hub (101) is connected to a vertical turbine blade (102) by way of a connecting strut (103), which is further supported by two support wires (104). The central hub (101) rotates around a vertical axis (105) and as it turns it drives roller bearings or the like within a distributed transmission element (106), which is integrated with a lower support structure (107). The example shows a configuration with a single strut although the wind turbine may comprise different numbers of blades in different embodiments. In the instance that the VAWT configuration uses a single blade such as in this example, a counterweight structure (108) may be employed to balance the central hub and blade and strut structure as it rotates. The counterweight (108) may comprise a semicircular shape and may comprise support rods (109) set at 120 degrees apart. Moreover the counterweight may be positioned in a plane lower than the point (110) where the blade system is connected to the central hub (101). For example, the counterweight may be positioned in a plane, which is up to one quarter of the height of the blade below the point (110) where the strut connects to the central hub (101).

For the single blade VAWT, a counterweight system is proposed which balances out the forces. The counterweight can take many different forms such as a static mass.

For wind turbine designs of power ranges from 4 kW to 80 kW, the VAWT blade design may comprise a symmetric airfoil and a self-starting mechanism co-located with the counterweight mass. In different embodiments the mass of the self-start mechanism may be sufficient to balance the weight of the single blade. An example of a single blade and self-start mechanism is shown in the lower part of FIG. 1. The self-start mechanism comprises two vertical curved blades (111) connected to the central hub connection point (110) by a short strut section (112). The mass of the short strut section and the self-start mechanism is chosen to balance the blade (102) and strut (103).

The two vertical curved blades (111) may typically be one eighth to one quarter the height of the blade (102).

The lower support structure comprises a plurality of power generation components comprising electrical generators and or hydraulic gearpumps. The location of the power generation components is radially separated from the axis of rotation (105) so that the torque upon the said components is reduced. Moreover, the reduced torque spread over a large number of components rather than a single centrally located electric generator makes possible a system comprising many smaller cheaper and more readily available power generation components.

In a first embodiment the invention makes possible the creation of a high power VAWT wind turbine, for example at a power of 4 MW. In this case the blade height would be between 40 m and 60 m high, the strut length would be between 50 m to 90 m long, and the diameter of the turning turbine would be between 40 m and 100 m. The diameter of the central hub and support column would be between 10 m and 30 m. In various configurations the total height of the VAWT turbine would be 50 m to 90 m high.

For a wind turbine of a different power class such as 40 kW, the blade height would be between 10 m and 14 m, the strut length would be between 7 m and 10 m, and the diameter of the turning turbine would be between 10 m and 18 m. The diameter of the central hub and support column would be between 1 m and 3 m. In various configurations the total height of the VAWT turbine would be 16 m to 20 m high.

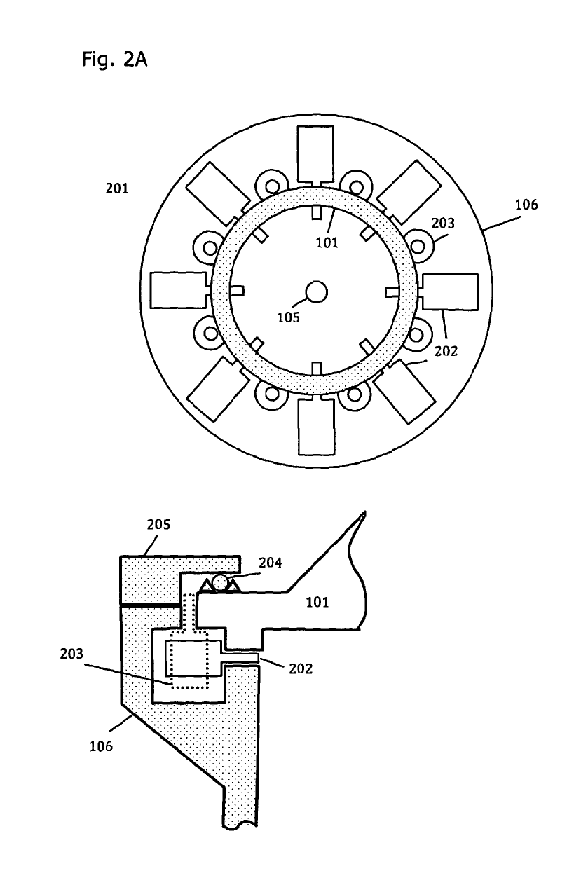

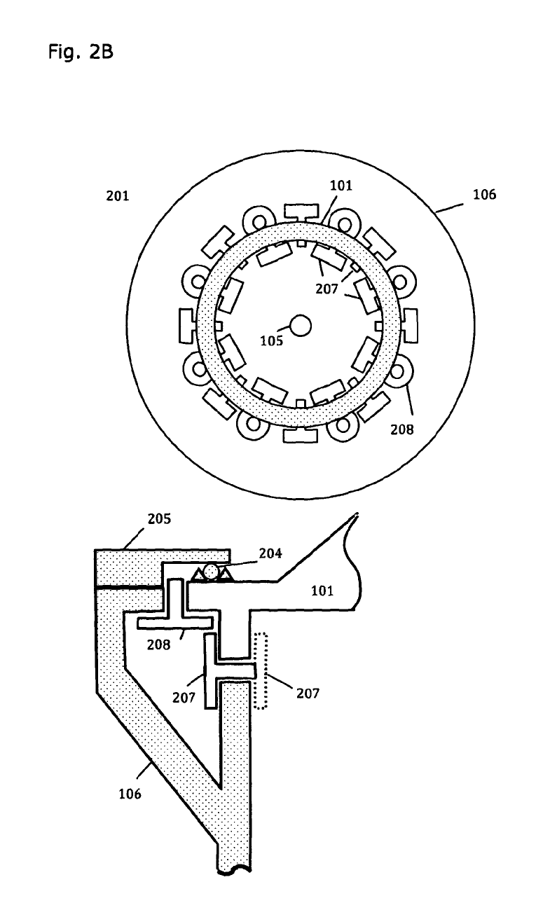

Now with reference to FIG. 2A is shown a schematic of the central hub power transfer coupling (201) where the central hub (101) interfaces with the distributed transmission element (106). In this configuration is shown one arrangement of hydraulic elements (202, 203) such as gearpumps or the like, which comprise roller bearings or the like and which form part of a hydraulic transmission system. The number and orientation of the hydraulic elements (202, 203) is dependent upon the power class of the wind turbine such as whether it is a 40 kW VAWT or a 4 MW VAWT and the available space and whether the hydraulic elements are of the same hydraulic fluid volume per cycle rating. By way of example, 16 hydraulic elements are shown. Eight hydraulic power generation elements are in the horizontal plane (202) and eight hydraulic elements are in the vertical plane (203). The rotation of the central hub (101) engages with the roller bearing elements associated with the hydraulic elements. As the central hub (101) rotates, the roller bearings cause the hydraulic elements to pump fluid, which are hydraulically connected to one or more hydraulic pipes and which drive one or more hydraulic elements associated with the electric power generation system (not shown). The hydraulic power generation components may be of the same or different power ratings and in different configurations they may be at different radial distances from the axis of rotation, thereby taking a different amount of torque from the rotating central hub (101).

The lower part of FIG. 2A shows a schematic of the interface between the central hub (101) and the hydraulic component roller bearings. A bearing (204) positioned in a groove (triangular cross section shown) engages with an enclosing ring (205) thereby securing the central hub to interface with the distributed transmission components within the distributed transmission element (106). Only two hydraulic components are shown, a horizontal component (202) and a vertical component (203) shown as a dotted line to help visualise the arrangement.

It must also be emphasised that this same central hub power transfer coupling is equally suitable for horizontal axis wind turbines (HAWTs).

Now with reference to FIG. 2B is shown an alternative configuration of the central hub power transfer coupling (201). In this figure is shown a representation of only electric power generation components such as permanent magnet generators and or asynchronous generators. In general and according to different embodiments, the power generation components may comprise a plurality of electric generators such as permanent magnet generators and or asynchronous generators and or hydraulic gearpumps and these power generation components may also be of different power ratings. Moreover the power generation components may be at the same distance from the central axis of rotation as shown or they may be at different distances from the axis of rotation, thereby taking a different amount of torque from the rotating central hub (101).

In particular with reference to FIG. 2B is shown a schematic of an alternative embodiment of the central hub power transfer coupling (201). In FIG. 2B is shown a configuration of 16 horizontal electric power components (207) and eight vertical electric power components (208). In this example the space requirement is generally less than for hydraulic power generation components as shown in the example of in FIG. 2A. As the central hub (101) rotates around the axis (105) it drives the roller bearings associated with each of the electric power components thus enabling the VAWT wind turbine to generate power.

The lower part of FIG. 2B shows a schematic of the interface between the central hub (101) and the electric power component roller bearings. A bearing (204) positioned in a groove (triangular cross section shown) engages with an enclosing ring (205) thereby securing the central hub to interface with the distributed transmission components within the distributed transmission element (106). In practice, the groove contains a plurality of bearings to engage the enclosing ring (205). Three electric power components are shown, 2 horizontal components (207) and a vertical element (208). One of the horizontal components (207) is shown as a dotted line to help visualise the arrangement.

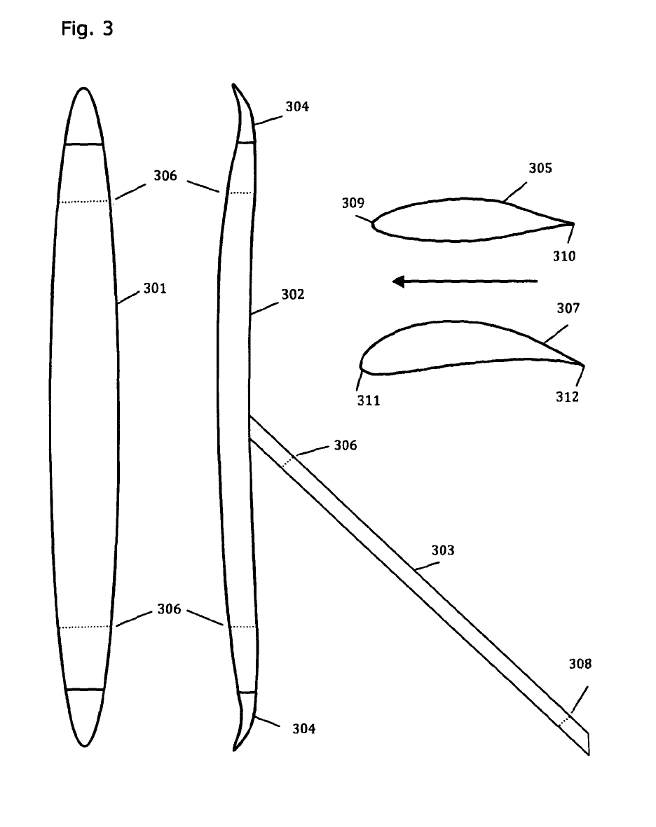

Now with reference to FIG. 3 is shown a schematic of a blade with front profile (301) and side profile (302), which may be used according to one preferred embodiment of the invention.

The front view of the blade (301) is elliptical in form. The side view of the blade (302) comprises a curved outer surface and a curved inner surface. A support strut (303) is fixed to the inner surface of the blade. The ends of the blade (304) curve outwards. In a preferred embodiment, the cross section of the blade has a symmetrical form (305). The cross section profile (305) has a smooth leading edge (309). The trailing edge of the blade has a tapering profile (310). The blade moves in the direction shown by the arrow. Generally, the profile (305) shows the form of the cross section of the blade at the locations marked with dotted lines (306). The strut (303) also comprises an aerodynamic profile to assist with lift of the blade. The profile of the strut may be uniform but in some embodiments it may change. In a preferred embodiment, the profile of the strut at the location close to where it attaches to the blade (306) comprises a cross section similar to (305) and the cross section of the strut close to where it attaches to the central hub (308) has a different profile (307). This non-symmetrical profile has a curved inner surface with a leading edge (311) and a trailing edge (312). The profile of the strut morphs smoothly between these two profiles (305 and 307).

In different embodiments the blade shape may be elliptical with angled tapering tips as shown or it may be of more uniform cross section with wing tips at each end. The angled strut also provides lift and this comprises an aerodynamic profile.

For the single blade VAWT, a counterweight system is proposed which balances out the forces. The counterweight can take many different forms such as a static mass.

In alternative embodiments the mass may be designed to teeter or move in and out as the wind turbine rotates. The teeter mechanism serves to reduce the forces on the system.

Alternatively a cam system could move the counterweight in and out and the position of the cam could be moved to track to be opposite the direction of the wind. This dynamic control of the teeter mechanism will provide better aerodynamic performance of the VAWT wind turbine.

In different embodiments the blade and counterweight system can be further developed such that the blade and counterweight swing in and out relative to one another. The single strut blade connection may comprise a hinge point. The movement of the blade would allow lift to be stored as potential energy to equalize the torque output of the turbine. In operation the hinge point can be moved in or out, or up or down. This mechanism would serve to reduce fatigue loadings.

In other embodiments the blade strut connection could comprise a pneumatic connection, which is servo-operated once per revolution.

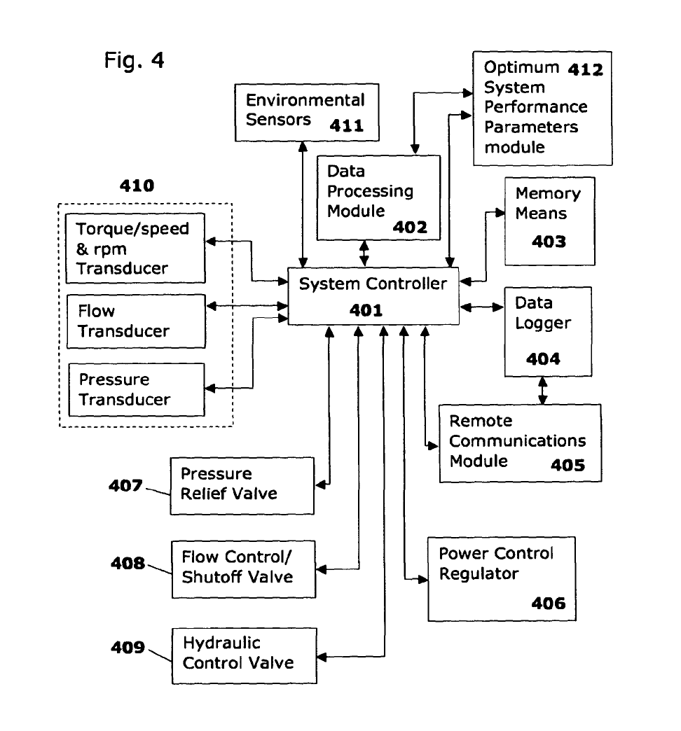

Now with reference to FIG. 4 each of the power generation components is linked to a central system controller (401), which controls whether one or more of the power components is switched on or off. The central system controller further comprises a fuzzy logic self-learning algorithm and a memory linked to a system database which makes possible intelligent power output control according to the prevailing and changing wind conditions at the turbine's location.

In one preferred embodiment, the VAWT wind turbine comprises a plurality of transducers and sensors, which gather data on the turbine operation, which is sent to the database (403) associated with the central system controller (401). The transducers (410) may include roller bearing torque transducers, and or speed transducers, and or rpm transducers. In the case that hydraulic components are used, flow and pressure transducers may be used. Other transducers may be added depending upon the application.

A memory means stores data about the system configuration. A data processing module (402) comprises a self-learning algorithm and serves to provide dynamic and optimized control of the electric generator output over a range of wind speeds. System parameters are stored in the optimum system performance parameters module (412).

The updating of the parameters stored in this module (412) continues with time as the self-learning algorithm in the data processing module (402) generates more performance data over a greater period of time and for an increasing range of environmental conditions. Real-time environmental data such as temperature, air pressure and the like is gathered by the system controller (401) via environmental sensors (411). In this way the data processing module (402) is able to map the system performance and the control settings of all the integrated control elements for a range of environmental conditions against the net output of the power generation components. In this way the optimum settings are determined to give the most efficient power generation over the operational range of the turbine. As described earlier, these are stored in the optimum performance parameters module (412) and continuously updated.

In particular, the system controller (401) applies the self-learning algorithms to optimise the net output of each and every power generation component for prevailing and changing wind conditions at the turbine's location.

A remote communications module (405) is connected to the system controller (401) and this can provide remote access to the turbine and the data logged and the system performance parameters.

The output of each power generation component is monitored continuously by a power control regulator (406). Depending upon the system configuration, the power control regulator (406) also serves to control how the power generated by the turbine is used. Electric power may be output directly to power local facilities, or to feed into the power grid. Alternatively, power may be used to recharge a local battery back-up supply.

Intelligent control of the electric generator may also be used to slow the turbine. In the instance that the generator is a permanent magnet generator (PMG), by controlling the excitation of the PMG, the magnetic flux density of the generator can be increased thereby making the generator shaft more difficult to turn. The level of excitation may be varied with reference to all other system parameters and the desired power output for any prevailing environmental conditions.

Control of power generation in higher wind speeds and changing wind conditions is thus made possible with reference to the optimum system performance parameters module (412). Differential control of all power control elements is dynamically applied with reference to the real-time environmental conditions as determined via the environmental sensors (411).

In particular, the output power regulation system described here is equally and advantageously applied to all types of wind turbine designs including horizontal axis wind turbines (HAWTs). The benefits to HAWTs are obvious to the man skilled in the art. The distributed power solution is ideally and efficaciously applied to the HAWT and can remove the need for massive transmission components at the top of the HAWT support tower.

In other embodiments, with suitable watertight connections, the same power conversion technology may be applied to submerged turbines and or be adapted to be used to derive power from moving water such as in a hydroelectric turbine.

While only several embodiments of the present invention have been described in detail, it will be obvious to those persons of ordinary skill in the art that many changes and modifications may be made thereunto without departing from the spirit of the invention. The present disclosure is for illustration purposes only and does not include all modifications and improvements, which may fall within the scope of the appended claims.

1. A wind turbine comprising a vertical axis wind turbine (VAWT) or a horizontal axis wind turbine (HAWT) comprising one or more turbine blades moving around an axis, and a central hub (101) connecting to one or more turbine blades (102), wherein said vertical axis wind turbine being characterised by;
said central hub (101) further rotating around a rotation axis (105) for driving a plurality of roller bearings within a distributed transmission element (106) integrated within a support structure (107), and
a plurality of power generation components comprising electrical generators and/or hydraulic pumps wherein
the location of said power generation components being radially separated from the rotation axis (105) in order to reduce the torque upon said power generation components by spreading said torque over a large number of components for allowing a system comprising a plurality of small power generation components.

2. A wind turbine comprising a vertical axis wind turbine (VAWT) as disclosed in claim 1 further comprising
a counterweight (108) for balancing the weight of a single turbine blade (102) connected to said connecting strut (103) in order to balance the structure of said central hub (101) and said single turbine blade (102) and said connecting strut (103) when said structure stationary or rotating

3. A vertical axis wind turbine (VAWT) as disclosed in claim 2 wherein said single turbine blade (102) further comprising;
a symmetric airfoil and a self-starting mechanism co-located with said counterweight mass suitable for said vertical axis wind turbine of power ranges from 4kW to 80kW, and/or
the mass of the self-start mechanism being sufficient for balancing the weight of said single turbine blade (102) and wherein
said self-start mechanism comprising two vertical curved blades (111) connected to said central hub.

4. A vertical axis wind turbine (VAWT) or a horizontal axis wind turbine (HAWT) as disclosed in claim 1 further comprising
a central hub power transfer coupling (201) wherein said central hub (101) interfacing with said distributed transmission element (106), and
a hydraulic transmission system comprising said plurality of roller bearings and a plurality of hydraulic elements (202, 203) such as hydraulic pumps, wherein
the rotation of said central hub (101) engaging with said plurality of roller bearings associated with said plurality of hydraulic elements (202,203), and
said plurality of roller bearings causing said plurality of hydraulic elements (202, 203) being hydraulically connected to a plurality of hydraulic pipes to pump fluid in order to drive one or a plurality of electric power generation systems wherein
each of said plurality of hydraulic elements (202,203) being associated with one or a plurality of said electric power generation systems.

5. A vertical axis wind turbine (VAWT) or a horizontal axis wind turbine (HAWT) as disclosed in claim 4 wherein the number and orientation of said plurality of hydraulic elements (202, 203) being dependent upon the available space, the power class of the wind turbine and whether said plurality of hydraulic elements (202, 203) being of the same or different hydraulic fluid volume per cycle rating, and of the same or different power ratings.

6. A vertical axis wind turbine (VAWT) or a horizontal axis wind turbine (HAWT) as disclosed in claim 5 wherein the interface between said central hub (101) and said plurality of hydraulic component roller bearings further comprising
a plurality of roller bearings (204) positioned in a groove engaged with an enclosing ring (205) for securing said central hub (101) to interface with the distributed transmission components within the distributed transmission element (106), and
a plurality of hydraulic elements (202) at a first orientation and a plurality of hydraulic elements (203) at a second orientation.

7. A vertical axis wind turbine (VAWT) or a horizontal axis wind turbine (HAWT) as disclosed in claim 1 further comprising
a central hub power transfer coupling (201) wherein said central hub (101) interfacing with said distributed transmission element (106), and
a transmission system comprising said roller bearings and electric power generation components (207, 208) such as permanent magnet generators and/or asynchronous generators, wherein
the rotation of said central hub (101) engaging with said roller bearings associated with said electric power generation components (207, 208), and
said roller bearings driving one or more of said electric power generation components (207, 208) associated with an electric power generation system.

8. A vertical axis wind turbine (VAWT) or a horizontal axis wind turbine (HAWT) as disclosed in claim 7 wherein the number and orientation of said electric power generation components (207, 208) being dependent upon the available space, the power class of the wind turbine, and wherein
each of said electric power generation components (207, 208) being of the same or different power ratings.

9. A vertical axis wind turbine (VAWT) or a horizontal axis wind turbine (HAWT) as disclosed in claim 8 wherein the interface between said central hub (101) and said plurality of component roller bearings further comprising
a plurality of roller bearings (204) positioned in a groove engaged with an enclosing ring (205) for securing said central hub (101) to interface with said plurality of distributed transmission components within the distributed transmission element (106), and wherein said plurality of electric power generation components being
a plurality of electric power generation components at a first orientation being permanent magnet generators or asynchronous generator elements (207), and
a plurality of electric power generation components at a second orientation being permanent magnet generators or asynchronous generator elements (208).

10. A vertical axis wind turbine (VAWT) as disclosed in claim 1 wherein said one or more turbine blades (102) further comprising
a front profile (301) elliptical in form and a side profile (302) comprising a curved outer surface and a curved inner surface, and wherein
the ends of said one or more turbine blades (304) being curved outwards, and
the cross section of said one or more turbine blades (102) having a symmetrical form (305) further comprising a smooth leading edge (309) and a tapering profile (310) at the trailing edge of said one or more turbine blades (102), and wherein
said one or more connecting struts (303) being fixed to the inner surface of said one or more turbine blades (102), or
wherein said one or more turbine blades (102) further comprising
an elliptical shape with angled tapering or having a more uniform cross section with wing tips at each end.

11. A vertical axis wind turbine (VAWT) as disclosed in claim 10 wherein said connecting strut (303) further comprising;
an aerodynamic profile, wherein
said aerodynamic profile having a symmetrical form (305) at the location close to where it attaches to said one or more turbine blades (306), and
said aerodynamic profile having a different profile (307) at the location close to where it attaches to said central hub (308), and further comprising a curved inner surface with a leading edge (311) and a trailing edge (312), and
said aerodynamic profile of said connecting strut (303) morphing smoothly between said two profiles (305 and 307), or
an aerodynamic profile, wherein
said profile of said connecting strut (303) having an elliptical shape with angled tapering providing lift, or
said connecting strut (303) further comprising a pneumatic connection to said one or more turbine blade (102), being servo-operated once per revolution.

12. A vertical axis wind turbine (VAWT) as disclosed in claim 1 wherein said VAWT having a power of 4MW, and
said turbine blade (102) height being between 40m and 60m high, and
said one or more connecting struts (103) length being between 50 m to 90 m long, and
the diameter of the turning turbine being between 40 m and 100 m, and
the diameter of said central hub (101) and support column being between 10 m and 30 m.

13. A vertical axis wind turbine (VAWT) as disclosed in claim 1 wherein said VAWT having a power of 40 kW and
said turbine blade (102) height being between 10 m and 14 m, and
said one or more connecting struts (103) length being between 7 m and 10 m, and
the diameter of the turning turbine being between 10 m and 18 m, and the diameter of said central hub (101) and support column being between 1 m and 3 m.

14. A wind turbine as disclosed in claim 1 wherein each of said power generation components being further linked to a central system controller (401), for controlling whether one or more of the power components being switched on or off, and
said central system controller (401) further comprising a data processing module (402) and a memory means (403) comprising system configuration data and linked to a system database allowing intelligent power output control according to the prevailing and changing wind conditions at the turbine's location, and
said wind turbine further comprising a plurality of transducers (410) and sensors (411) and/or roller bearing torque transducers and/or speed transducers and/or or rpm transducers and/or flow and/or pressure transducers for gathering data on the turbine operation, wherein said gathered data being sent to said database (403).

15. A wind turbine as disclosed in claim 14 wherein said central system controller (401) further comprising;
a self-learning algorithm for providing dynamic and optimized control of the electric generator output over a range of wind speeds, and
an optimum system performance parameters module (412) wherein system parameters are stored, and wherein
said self-learning algorithm further generating performance data over a period of time for updating the parameters stored in an optimum performance parameters module (412) for a range of measured environmental conditions and measured output of said power generation components, and
real-time environmental data such as temperature and or air pressure being gathered by said central system controller (401) via environmental sensors (411) allowing dynamic control of the wind turbine power generation components.

16. A wind turbine as disclosed in claim 15 wherein
said data processing module (402) mapping the system performance and the control settings of all the integrated control elements for determining the optimum settings to provide optimum power generation over the operational range of said wind turbine, and
said central system controller (401) applying said self-learning algorithms to optimise the net output of each of said power generation components for prevailing and changing wind conditions at the turbine's location, and
the output of each of said power generation components being monitored by a power control regulator (406), wherein
said power control regulator (406) controlling the wind turbine power output.

17. A wind turbine as disclosed in claim 16 further comprising
a remote communications module (405) connected to said central system controller (401) for providing a remote access to the wind turbine and the data logged and the system performance parameters.

18. A method for generating power by means of a wind turbine such as a vertical axis wind turbine (VAWT) or a horizontal axis wind turbine (HAWT) comprising one or more turbine blades moving around an axis, and a central hub (101) connecting to one or more turbine blades (102), wherein said method being characterised by the steps of;
rotating said central hub (101) around a rotation axis (105) for driving a plurality of roller bearings within a distributed transmission element (106) integrated within a support structure (107), and
generating power by means of a plurality of power generation components comprising electrical generators and/or hydraulic pumps wherein
the location of said power generation components being radially separated from the rotation axis (105) in order to reduce the torque upon said power generation components by spreading said torque over a large number of components for allowing a system comprising a plurality of small power generation components.

19. A method for generating power by means of a wind turbine as disclosed in claim 18 further comprising the steps of;
interfacing said central hub (101) with said distributed transmission element (106), and
engaging the rotation of said plurality of roller bearings associated with a plurality of hydraulic elements (202,203) by the rotation of said central hub (101), wherein
a hydraulic transmission system being formed by said plurality of roller bearings and said plurality of hydraulic elements (202, 203) such as hydraulic pumps, and said plurality of roller bearings further
causing said plurality of hydraulic elements (202, 203) being hydraulically connected to a plurality of hydraulic pipes to pump fluid, and
driving one or a plurality of electric power generation system wherein
each of said plurality of hydraulic elements (202,203) being associated with one or a plurality of said electric power generation systems.

20. A method for generating power by means of a vertical axis wind turbine (VAWT) as disclosed in claim 18 wherein said one or more turbine blades (102) further comprising;
a front profile (301) elliptical in form and a side profile (302) comprising a curved outer surface and a curved inner surface, and wherein
the ends of said one or more turbine blades (304) being curved outwards, and
the cross section of said one or more turbine blades (102) having a symmetrical form (305) further comprising a smooth leading edge (309) and a tapering profile (310) at the trailing edge of said one or more turbine blades (102), and wherein
said connecting strut (303) being fixed to the inner surface of said one or more turbine blades (102), or
wherein said one or more turbine blades (102) further comprising
an elliptical shape with angled tapering or having a more uniform cross section with wing tips at each end.

21. A method for generating power by means of a vertical axis wind turbine (VAWT) as disclosed in claim 20 wherein
said connecting strut (303) further comprising an aerodynamic profile, wherein
said aerodynamic profile having a symmetrical form (305) at the location close to where it attaches to said one or more turbine blades (306), and
said aerodynamic profile having a different profile (307) at the location close to where it attaches to said central hub (308), and further comprising a curved inner surface with a leading edge (311) and a trailing edge (312), and
said aerodynamic profile of said connecting strut (303) morphing smoothly between said two profiles (305 and 307), or
said connecting strut (303) further comprising an aerodynamic profile, wherein
said profile of said connecting strut (303) having an elliptical shape with angled tapering providing lift, or
said connecting strut (303) further comprising a pneumatic connection to said one or more turbine blade (102), being servo-operated once per revolution.

22. A method for generating power by means of a wind turbine as disclosed in claim 19 wherein the interface between said central hub (101) and the hydraulic component roller bearings further comprising
a plurality of roller bearings (204) positioned in a groove engaged with an enclosing ring (205) for securing said central hub (101) to interface with the distributed transmission components within the distributed transmission element (106), and
a plurality of said hydraulic elements (202) at a first orientation and a plurality of said hydraulic elements (203) at a second orientation.

23. A method for generating power by means of a wind turbine as disclosed in claim 19 wherein the interface between said central hub (101) and the component roller bearings further comprising
a plurality of roller bearings (204) positioned in a groove engaged with an enclosing ring (205) for securing said central hub (101) to interface with the distributed transmission components within the distributed transmission element (106), and wherein said electric power generation components being
a plurality of electric power generation components at a first orientation being permanent magnet generators or asynchronous generators elements (207), and
a plurality of electric power generation components at a second orientation being permanent magnet generators or asynchronous generators elements (208).

24. A method for generating power by means of a wind turbine as disclosed in claim 19 further comprising the steps of;
controlling whether one or more of the power components being switched on or off by a central system controller (401) comprising a data processing module (402), wherein
said central system controller (401) being linked to each of said power generation components, and
gathering data on the turbine operation by a plurality of transducers (410) and sensors (411), and/or roller bearing torque transducers, and/or speed transducers, and/or or rpm transducers, and/or flow and/or pressure transducers, and
sending said gathered data to said database (403), and
processing said gathered data on the turbine operation by said data processing module (402) and storing said processed data in a memory means (403) further comprising
system configuration data and linked to a system database for allowing intelligent power output control according to the prevailing and changing wind conditions at the turbine's location.

25. A method for generating power by means of a wind turbine as disclosed in claim 24 further comprising the steps of;
providing dynamic and optimized control of the electric power output over a range of wind speeds by means of a self-learning algorithm wherein
said central system controller (401) further comprising said self-learning
algorithm, and an optimum system performance parameters module (412)
wherein system parameters are stored, and
generating performance data over a period of time for updating the parameters stored in said optimum performance parameters module (412) for a range of environmental conditions against the net output of said power generation components by said self-learning algorithm, and
gathering real-time environmental data being temperature or air pressure by said central system controller (401) via environmental sensors (411) allowing dynamic control of all power generation components.

26. A method for generating power by means of a wind turbine as disclosed in claim 25 further comprising the steps of;
mapping the system performance and the control settings of all the integrated control elements for determining the optimum settings to provide optimum power generation over the operational range of said wind turbine by said data processing module (402), and
applying said self-learning algorithms to optimise the net output of each of said power generation components for prevailing and changing wind conditions at the turbine's location by said central system controller (401), and
continuously monitoring the output of each of said power generation components by a power control regulator (406), wherein
said power control regulator (406) controlling the wind turbine power output.

27. A method for generating power by means of a wind turbine as disclosed in claim 26 further comprising the steps of;
connecting a remote communications module (405) to said central system controller (401) for providing remote access and control to the wind turbine and the data logged and the system performance parameters.
